(19) United States
(12) Patent Application Publication
(10) Pub. No.: US 2006/0228559 A1
(43) Pub. Date: Oct. 12, 2006

(54) Optical bodies with optical films having specific functional layers

(75) Inventors: Martin E. Denker, Vadnais Heights, MN (US); Kristopher J. Derks, Woodbury, MN (US); Timothy J. Hebrink, Scandia, MN (US); Clinton L. Jones, Somerset, WI (US); Jeffery N. Jackson, Woodbury, MN (US); Mark B. O'Neill, Stillwater, MN (US); Terry O. Collier, Woodbury, MN (US); Matthew B. Johnson, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/398,010

(22) Filed: Apr. 5, 2006

Related U.S. Application Data
(60) Provisional application No. 60/668,873, filed on Apr. 6, 2005.

(51) Int. Cl. B32B 27/36; B32B 27/00; B32B 27/32

(52) U.S. Cl. 428/412; 428/480; 428/523; 428/500

(57) ABSTRACT

An optical body including an optical film, a first layer on a first major surface of the optical film, and a second layer on a second major surface of the optical film, wherein at least one of the first and second layers may include an adhesion-promoting layer that comprises a polycarbonate/polyester blend resin or a styrene copolymer. The present disclosure is also directed to an optical body wherein at least one of the first and second layers may include an imprint-resistant layer that comprises a polymer selected from the group consisting of crystalline polyesters, copolyesters, olefin homopolymers and olefin copolymers.

### CROSS-REFERENCE TO RELATED APPLICATION

This application is a non-provisional application claiming the benefit of priority from U.S. Provisional Application Ser. No. 60/668,873, filed Apr. 6, 2005, entitled, “Optical Bodies with Optical Films Having Specific Functional Layers.”

### TECHNICAL FIELD

The present disclosure relates to specialized materials and combinations of materials for optical films and optical film constructions. The present disclosure further relates to optical display components including the optical film constructions.

### BACKGROUND

Optical films, including optical brightness enhancement films, are widely used for various purposes, particularly in optical displays. Multilayer optical films are typically made of alternating layers of polymeric materials with indices of refraction selected to provide specific optical properties. For example, the alternating layers, sometimes referred to as an optical stack, may act as reflective polarizers or mirrors, reflecting light of all polarizations. They may also be wavelength selective reflectors such as “cold mirrors” that reflect visible light but transmit infrared or “hot mirrors” that transmit visible and reflect infrared. Examples of a wide variety of multilayer optical stacks that may be constructed are included in, for example, U.S. Pat. No. 5,882,774. Exemplary applications include electronic displays, including liquid crystal displays (LCDs) placed in mobile telephones, personal data assistants, computers, televisions and other devices. Exemplary optical films particularly useful in LCDs include those available from 3M Company, St. Paul, Minn., under the trade designations Vikuiti Brightness Enhancement Film (BEF), Vikuiti Dual Brightness Enhancement Film (DBEF) and Vikuiti Diffuse Reflective Polarizer Film (DRPF). Other widely used optical films include reflectors, such as those available from 3M Company under the trade designation Vikuiti Enhanced Specular Reflector (ESR).

Although optical films can have favorable optical and physical properties, their surfaces can be damaged. Damage such as scratching, denting, particle contamination, and embossing by other components may occur during manufacturing, handling and transport, as well as in use in an optical display application. Some of these defects can render the optical films unusable or can necessitate their use only in combination with additional diffusers to hide the defects from the viewer. Eliminating, reducing or hiding defects on optical films and other components is particularly important in displays that are typically viewed at close distance for extended periods of time. It is also useful to hide lighting components positioned behind the optical films, such as fluorescent tubes or LED lights.

### SUMMARY

In one aspect, the present disclosure is directed to an optical body including an optical film, a first layer on a first major surface of the optical film, and a second layer on a second major surface of the optical film, wherein at least one of the first and second layers is an adhesion-promoting layer that includes a polycarbonate/polyester blend resin. In another aspect, the present disclosure is directed to an optical body including an optical film, a first layer on a first major surface of the optical film, and a second layer on a second major surface of the optical film, wherein the first layer is an adhesion-promoting layer that includes a polycarbonate/polyester blend resin or a styrene copolymer, and wherein the second layer is an imprint-resistant layer that includes a polymer selected from the group consisting of crystalline polyesters, copolyesters, olefin homopolymers and olefin copolymers, and, optionally, a structured surface film on at least one of the first and second layers.

In yet another aspect, the present disclosure is directed to an optical body including an optical film, a first layer on a first major surface of the optical film, and a second layer on a second major surface of the optical film, wherein at least one of the first and second layers is an imprint-resistant layer that includes a polymer selected from the group consisting of crystalline polyesters, copolyesters, olefin homopolymers and olefin copolymers, and a structured surface film on at least one of the first and second layers.

The details of one or more exemplary embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a cross-sectional schematic view of an optical body including a multilayer reflective polarizing optical film having applied thereto a prismatic layer;

FIG. 2 is a cross-sectional schematic view of a display construction including the film construction of FIG. 1 and an additional layer of a structured surface film;

FIG. 3 is a cross-sectional schematic view of an optical body of an exemplary embodiment of the present disclosure;

FIG. 4 is a cross-sectional schematic view of an optical body of an exemplary embodiment of the present disclosure including a structured surface film;

FIG. 5 is a cross-sectional schematic view of a display construction including the film construction of FIG. 4 and an additional layer of a structured surface film; and

FIG. 6 is a schematic representation of an imprint resistance tester that may be used to evaluate the damage resistance of the optical bodies constructed according to the present disclosure.

While the above-identified drawing figures set forth several exemplary embodiments of the disclosure, other embodiments are also contemplated. This disclosure presents illustrative embodiments of the present invention by way of representation and not limitation. Numerous other modifications and embodiments can be devised by those skilled in the art which fall within the scope and spirit of the principles of the present disclosure. The drawing figures are not drawn to scale.

Moreover, while embodiments and components may be referred to by the designations “first,” “second,” “third,” etc., it is to be understood that these descriptions are bestowed for convenience of reference and do not imply an order of preference. The designations are presented merely to distinguish between different embodiments for purposes of clarity.

Unless otherwise indicated, all numbers expressing feature sizes, amounts, and physical properties used in the specification and claims are to be understood as being modified in all instances by the term “about.” Accordingly, unless indicated to the contrary, the numbers set forth are approximations that can vary depending upon the desired properties using the teachings disclosed herein.

### DETAILED DESCRIPTION

U.S. Pat. No. 6,368,699, incorporated herein by reference, describes a multilayer optical film having adhered to one or both of its major surfaces at least one additional layer selected for mechanical, chemical, or optical properties that differ from the properties of the materials of the layers of the optical stack. Multilayer optical stacks may provide significant and desirable optical properties, but other properties, which may be mechanical, optical, or chemical, could also be desired. Such properties may be provided by including one or more layers with the optical stack that provide these properties while not contributing to the primary optical function of the optical stack itself. If a layer is provided on a major surface of the optical stack, it may be referred to as a “skin layer.” If a layer is provided within the optical stack of film layers, it may be referred to as a “protective boundary layer (PBL).”

The additional layers may be coextruded, for example, on one or both major surfaces of a multilayer optical stack as it is manufactured to protect the multilayer stack from the high shear along the feedblock and die walls. After the protected multilayer stack emerges from the feedblock, one or more additional skin layers may optionally be applied. Protective boundary layers and/or skin layers are applied at different points in the process of manufacturing the multilayer optical film, but each can have a similar protective function. For the purposes of this application, the term “multilayer optical film” includes any optional protective boundary layers, while the optically active construction of alternating polymeric layers in the multilayer optical film will be referred to as the “optical stack.”

Copending and commonly owned U.S. patent application Ser. No. 10/977,211, filed Oct. 29, 2004, incorporated herein by reference, describes rough strippable skin layers that can be connected or, in some embodiments, operatively connected, to a multilayer optical film. The term “strippable skin layer” refers to layers capable of remaining adhered to the optical film for as long as desired, e.g., during initial processing, storage, handling, packaging, transporting and subsequent processing, but which can subsequently be removed and sometimes reapplied as necessary in a particular application. Other commonly owned U.S. patent application Ser. Nos. 11/099,860; 11/100,191; and 60/668,700, filed concurrently herewith on Apr. 6, 2005 and incorporated herein by reference, describe strippable boundary layers and rough strippable boundary layers incorporated into optical bodies.

Multilayer films having the optical properties of reflective polarizers (such as those available from 3M Company, St. Paul, Minn. under the trade designation Vikuiti Dual Brightness Enhancement Film, or DBEF) are frequently used with a structured surface film such as, for example, a prismatic brightness enhancement film available from 3M Company under the trade designation Vikuiti Brightness Enhancement Film, or BEF, to maximize the amount of light directed at the viewer of backlit liquid crystal (LC) displays and to reduce power consumption through light recycling. Recently, film products have been introduced that contain both reflective polarizer and prismatic film components in one unitary construction.

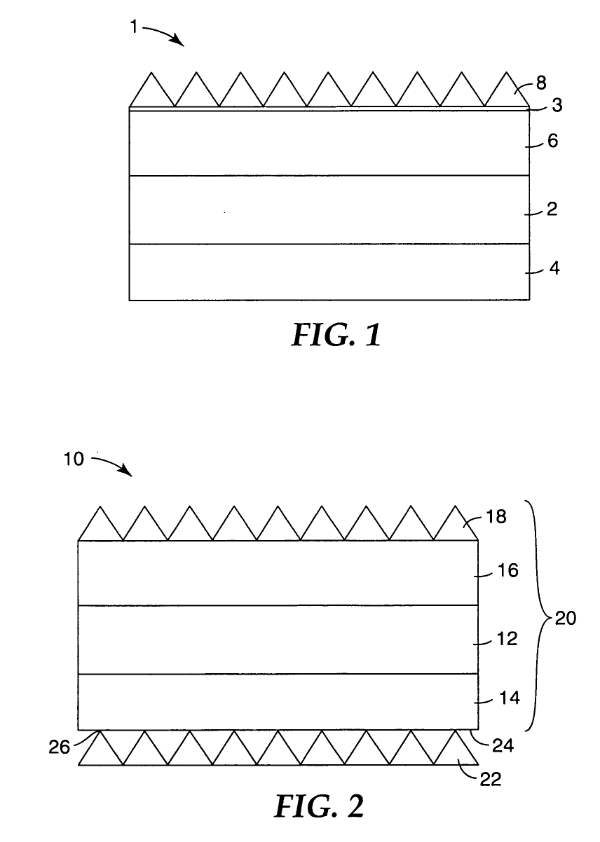

The optical body 1 in FIG. 1 includes an optical film 2, such as a multilayer optical film with an optical stack of alternating layers of polymers having refractive indices selected to form a polarizer. The optical film 2 includes a first layer 4 and a second layer 6. In one embodiment, to provide enhanced compatibility with and adhesion to the optical film 2, the layers 4 and 6 are selected from the same materials used in the optical film 2, e.g., the same materials used in the alternating layers of the optical stack of a multilayer optical film. For example, in a reflective polarizer including a stack of alternating layers of PEN and CoPEN, tear resistant outer surface layers of CoPEN may be coextruded onto the optical film 2 during the manufacturing process. A coating, such as a coating of a curable material, may be applied on a surface layer 6 and a structured surface may be formed thereon. The structured surface may include prisms with a similar microstructure to that found on a prismatic brightness enhancement film 8 such as BEF. Such unitary construction of a polarizing film and a structured surface film is available under the trade designation BEF-RP from 3M Company. However, those of ordinary skill in the art will readily appreciate that any suitable structured surfaces are within the scope of the present disclosure. Suitable examples of coating materials into which the surface structures may be imparted include radiation-curable resins.

To ensure acceptable adhesion of the coating to the film while maintaining good release properties of the coating from the tool used to form the structures on the structured surface layer, a layer 3 of a primer may be coated on the optical film 2 or on the layer 6 before the coating is applied. The primer may be coated on the optical film 2 or layer 6 prior to or after orientation, where appropriate.

The priming of multilayer films such as DBEF usually uses primer coating and drying steps prior to or after stretching the film. Elimination of the primer coating step may result in yield gains.

Referring to FIG. 2, an optical body 20, which may be the optical body described with reference to FIG. 1, is frequently utilized in a display with an additional sheet of a structured surface film 22 such as, for example, BEF, to form an optical body 10. An optical film 12, which may be a multilayer optical film with alternating layers of polymers that, when oriented, have refractive indices selected to form a reflective polarizer (RP), has applied thereto a first surface layer 14, which may be an imprint-resistant layer, and a second surface layer 16, which may be an adhesion-promoting layer. Adjacent the second surface layer 16 is applied a structured surface layer 18 having a structured surface that faces away from the optical film 12 and the layer 16. The combination of the optical film 12, layers 14 and 16, and the structured surface layer 18 is referred to as optical body 20. To further enhance the brightness of an optical display, an additional sheet 22 of a structured surface film, such as BEF, is placed in the display beneath the optical body 20 and adjacent to an exterior surface 24 of the first surface layer 14. Those of ordinary skill in the art will readily appreciate that exemplary embodiments of the present disclosure will be beneficial with any structured surface film that has protruding surface structures that face the optical film 12 and may produce indentations in the adjacent surface of the optical body 20. For instance, the tips of the structures 26 in the structured surface film 22, illustrated as prisms in FIG. 2 but not limited thereto, are oriented toward the surface 24 of the first surface layer 14.

Under certain conditions of time, temperature and force, the optical body 20 and the structured surface film 22 come into contact, and the surface structures 26 may indent or emboss the surface 24 of the skin layer 14 of the optical film 12 or the structures 26 may become embedded into the surface 24. This damage often shows up as undesirable visible indentations on the surface 24. Such damage may be alleviated by an additional hard coating step or a change in application design, for example.

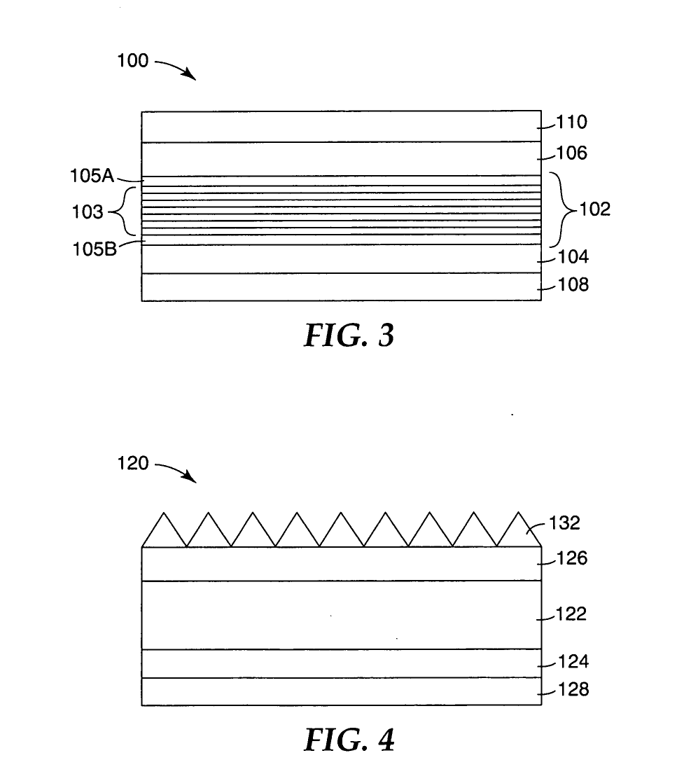

Referring to FIG. 3, an optical body 100 is shown including an optical film 102 such as, for example, a multilayer optical film. In one embodiment, the multilayer optical film includes an optical stack 103 having alternating polymeric layers with refractive indices selected such that when at least one of the materials in the optical stack 103 is oriented, the optical stack 103 forms a reflective polarizer. For the purposes of this application, the optical film 102 may be a multilayer optical film, an optical film including a disperse and continuous phase, or any other suitable optical film construction.

Other additional optical and non-optical layers (not shown in FIG. 3) may be included in the optical stack, e.g. between any of the optical layers or over any of the layers. Optional protective boundary layers 105A and 105B, which may include the same or different materials as those of the optical film 102, may be present on one or both major surfaces of the optical film 102, for example, on one or both major surfaces of the optical stack 103 in case of a multilayer optical film. One or both protective boundary layers 105A, 105B may be single layers or may include multiple layers of different materials. The protective boundary layers 105A and 105B may be permanently adhered to the optical film 102 or may be strippable—i.e. removable from the optical stack 103 when desired but capable of remaining on the optical film 102 as long as desired.

One or both skin layers 104 and 106 may be applied to the protective boundary layers 105A, 105B, if present, or may be applied directly to the optical film 102 if the protective boundary layers 105A, 105B are not present in the film construction. The skin layers may be single layer or may include multiple layers of different materials. The skin layers 104, 106 may be permanently adhered to the protective boundary layers 105A, 105B or may be strippable. One or both layers 104 and 106 may be adhesion-promoting or imprint resistant layers. In some exemplary embodiments, one of the layers 104 ond 106 is an adhesion-promoting layer, while the other one is an imprint-resistant layer.

In one embodiment, one or both of the protective boundary layers 105A, 105B and/or the skin layers 104 and 106 are adhesion-promoting layers that are made of or include amorphous polymers such as, for example, polycarbonate/polyester blend resins, acrylates and acrylate copolymers, styrene and styrene copolymers such as, for example styrene acrylonitrile (SAN) and styrene acrylate copolymer, and copolyesters. Suitable examples of the polycarbonate/polyester blend resins include polyester/polycarbonate alloys available from Bayer Plastics, Pittsburgh, Pa., under the trade designation Makroblend; those available from GE Plastics, Pittsfield, Mass., under the trade designation Xylex; and those available from Eastman Chemical, Kingsport, Tenn., such as Eastman Chemical SA 115. In another embodiment, at least one of the protective boundary layers 105A, 105B, the skin layers 104, 106 and some of the layers of the optical stack 103 where the optical film 102 is a multilayer optical film, is made of a polycarbonate/polyester blend resin, an amorphous polyester, or a polystyrene copolymer such as SAN. In some exemplary embodiments, the adhesion promoting layer or layers may also have the additional functionality of imprint resistance. For example, this may occur where a polycarbonate/polyester blend layer or a polystyrene copolymer layer is thin enough to develop crystallinity.

The optical body 100 may also include optional strippable protective layers 108, 110. These removable protective layers can reduce the deposit of foreign material onto the optical film 102 and make the film 102 more robust. In some exemplary embodiments, strippable skin layers 108, 110 may roughen or otherwise impart texture to an adjacent surface of the optical film 102 or of the layers 104, 106. In an exemplary embodiment, strippable layers 108, 110 are made of polyolefins such as, for example, polypropylene and its copolymers with polyethylene.

The optical body 100 shown in FIG. 3 may have applied thereto a structured surface layer 132, such that the surface structures face away from the optical film 102, to form an optical body 120 shown in FIG. 4. The optical body 120 includes an optical film 122 such as, for example, a multilayer optical film having an optical stack with alternating polymeric layers of materials having refractive indices selected to form, when oriented, a reflective polarizer. Adjacent to the optical film 122 lie layers 124, 126, one or both of which may be an adhesion promoting layer made of polycarbonate/polyester blend resins such as, for example, polyester/polycarbonate alloys available from Bayer Plastics under the trade designation Makroblend; those available from GE Plastics under the trade designation Xylex; and those available from Eastman Chemical, such as Eastman Chemical SA 115. The layers 124, 126 may be skin layers, protective boundary layers, or layers making up the optical stack of the optical film 122, as suitable for a particular application.

In one embodiment, the polycarbonate/polyester blend resins of one or both layers 124, 126 are selected to be inherently receptive to the monomers making up the structured surface layer 132, so no intermediate primer layer is required prior to application of the layer 132 (typically coating is the preferred method of application). Selection of materials for one or both of the layers 124, 126 that adhere sufficiently to the structured surface layer 132 eliminates the material and processing costs associated with application of an intermediate primer layer and reduces yield losses caused by damage to the optical film that may sometimes occur during an extra primer coating step. Optional strippable layer 128 may remain in place following application of the structured surface layer 132 to protect the opposed side of the optical film 122.

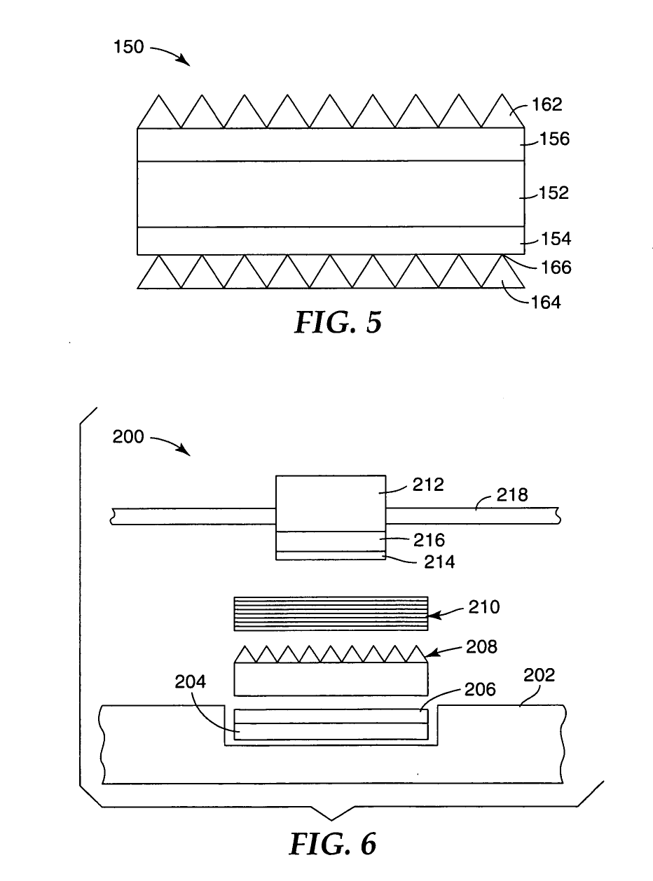

Typically, when the optical body 120 shown in FIG. 4 is used in an optical display, the optional strippable layer 128 (if present) has been removed, and the remainder of the optical body 120 is placed adjacent to a structured surface film. Referring to FIG. 5, a portion of an optical display 150 includes a display panel (not shown), a backlight (not shown), and an optical film 152 disposed for example between the display panel and the backlight. The optical film 152 may be a multilayer optical film with an optical stack of alternating polymeric layers having refractive indices selected to form, when oriented, a reflective polarizer. Adjacent to the optical film 152 lie layers 154, 156 that may be skin layers, protective boundary layers, or layers of the optical stack. At least one layer 154, 156 is an adhesion-promoting layer made of polycarbonate/polyester blend resins such as, for example, polyester/polycarbonate alloys available from Bayer Plastics under the trade designation Makroblend; those available from GE Plastics under the trade designation Xylex; and those available from Eastman Chemical, such as Eastman Chemical SA 115. A structured surface layer 162 may be applied directly onto the adhesion-promoting layer 156, and no intermediate primer layer is required in an exemplary embodiment. A structured surface film 164 is placed adjacent the layer 154 in an exemplary embodiment.

In another embodiment, the composition of the layer 154 may be altered to further improve the resistance of the layer 154 and the optical film 152 to damage from, for example, indenting or embossing, caused by the structures or projections 166 of the structured surface film 164, if the structured surface film 164 is disposed such that its structured surface including the structures 166 faces the optical film 152. In such exemplary embodiments, the layer 154 is an imprint-resistant layer. Polymers and copolymers with increased chemical and physical resistance are preferred to improve the damage resistance of the imprint-resistant layer 154.

A wide variety of polymeric materials, when processed under appropriate conditions, such as, for example, preheat temperature, orientation temperature, stretch rate, line speed, stretch ratio, post-orientation heat setting and draw reduction (e.g. toe-in), and the like, will possess suitable chemical and physical properties, particularly crystallinity, to enhance the damage resistance of the imprint-resistant layer 154. Suitable damage resistant polymeric materials include, for example, crystalline polyesters and copolyesters such as PEN and CoPEN, and olefin homopolymers and copolymers, including amorphous cyclic olefin copolymers such as, for example, norbornene-based polymers available from Ticona Engineering Polymers, Summit, N.J. under the trade designation TOPAS.

Various methods may be used for forming the film constructions of the present disclosure, which may include extrusion blending, coextrusion, film casting and quenching, lamination and orientation. As stated above, the film constructions can take on various configurations, and thus the methods vary depending upon the configuration and the desired properties of the final optical body.

Optical Films

Various optical films that are suitable for use in the embodiments of the present disclosure can include dielectric multilayer optical films (whether composed of all birefringent optical layers, some birefringent optical layers, or all isotropic optical layers), such as DBEF and ESR, and continuous/disperse phase optical films, such as DRPF, which can be characterized as polarizers or mirrors. The optical films can include a prismatic film, such as BEF, or another optical film having a structured surface.

In some exemplary embodiments, the optical film can be or can include a diffuse micro-voided reflective film, such as BaSO₄-filled polyethylene terephthalate (PET), or diffuse “white” reflective film such as TiO₂-filled PET. Alternatively, the optical film can be a single layer of a suitable optically clear material such as polycarbonate, which may or may not include volume diffusers. Those of ordinary skill in the art will readily appreciate that the structures, methods, and techniques described herein can be adapted and applied to other types of suitable optical films. The optical films specifically mentioned herein are merely illustrative examples and are not meant to be an exhaustive list of optical films suitable for use with exemplary embodiments of the present disclosure.

Exemplary optical films that are suitable for use in the present invention include multilayer reflective films such as those described in, for example, U.S. Pat. Nos. 5,882,774 and 6,352,761 and in PCT Publication Nos. WO95/17303; WO95/17691; WO95/17692; WO95/17699; WO96/19347; and WO99/36262, all of which are incorporated herein by reference. Both multilayer reflective optical films and continuous/disperse phase reflective optical films rely on index of refraction differences between at least two different materials (typically polymers) to selectively reflect light of at least one polarization orientation. Suitable diffuse reflective polarizers include the continuous/disperse phase optical films described in, for example, U.S. Pat. No. 5,825,543, incorporated herein by reference, as well as the diffusely reflecting optical films described in, for example, U.S. Pat. No. 5,867,316, incorporated herein by reference.

In some embodiments the optical film is a multilayer stack of polymer layers with a Brewster angle (the angle at which reflectance of p-polarized light turns to zero) that is very large or nonexistent. Multilayer optical films can be made into a multilayer mirror or polarizer whose reflectivity for p-polarized light decreases slowly with angle of incidence, is independent of angle of incidence, or increases with angle of incidence away from the normal. Multilayer reflective optical films are used herein as an example to illustrate optical film structures and methods of making and using the optical films of the invention. As mentioned above, the structures, methods, and techniques described herein can be adapted and applied to other types of suitable optical films.

For example, a suitable multilayer optical film can be made by alternating (e.g., interleaving) uniaxially- or biaxially-oriented birefringent first optical layers with second optical layers. In some embodiments, the second optical layers have an isotropic index of refraction that is approximately equal to one of the in-plane indices of the oriented layer. The interface between the two different optical layers forms a light reflection plane. Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers.

A film having multiple layers can include layers with different optical thicknesses to increase the reflectivity of the film over a range of wavelengths. For example, a film can include pairs of layers that are individually tuned (for normally incident light, for example) to achieve optimal reflection of light having particular wavelengths. Generally, multilayer optical films suitable for use with certain embodiments of the invention have about 2 to 5000 optical layers, typically about 25 to 2000 optical layers, and often about 50 to 1500 optical layers or about 75 to 1000 optical layers. It should further be appreciated that, although only a single multilayer stack may be described, the multilayer optical film can be made from multiple stacks or different types of optical film that are subsequently combined to form the film. The described multilayer optical films can be made according to U.S. patent application Ser. No. 09/229,724 and U.S. Pat. No. 6,827,886, which are both incorporated herein by reference.

A polarizer can be made by combining a uniaxially oriented first optical layer with a second optical layer having an isotropic index of refraction that is approximately equal to one of the in-plane indices of the oriented layer. Alternatively, both optical layers are formed from birefringent polymers and are oriented in a stretching process so that the indices of refraction in a single in-plane direction are approximately equal. The interface between the two optical layers forms a light reflection plane for one polarization of light.

Light polarized in a plane parallel to the direction in which the indices of refraction of the two layers are approximately equal will be substantially transmitted.

Light polarized in a plane parallel to the direction in which the two layers have different indices will be at least partially reflected. For polarizers having second optical layers with isotropic indices of refraction or low in-plane birefringence (e.g., no more than about 0.07), the in-plane indices (nx and ny) of refraction of the second optical layers are approximately equal to one in-plane index (e.g., ny) of the first optical layers. Thus, the in-plane birefringence of the first optical layers is an indicator of the reflectivity of the multilayer optical film. Typically, it is found that the higher the in-plane birefringence, the better the reflectivity of the multilayer optical film. If the out-of-plane indices (nz) of refraction of the first and second optical layers are equal or nearly equal (e.g., no more than 0.1 difference and preferably no more than 0.05 difference), the multilayer optical film also has better off-angle reflectivity.

In one embodiment, a mirror can be made using at least one uniaxially birefringent material, in which two indices (typically along the x and y axes, or nx and ny) are approximately equal, and different from the third index (typically along the z axis, or nz). The x and y axes are defined as the in-plane axes, in that they represent the plane of a given layer within the multilayer film, and the respective indices nx and ny are referred to as the in-plane indices. One method of creating a uniaxially birefringent system is to biaxially orient (stretch along two axes) the multilayer polymeric film. If the adjoining layers have different stress-induced birefringence, biaxial orientation of the multilayer film results in differences between refractive indices of adjoining layers for planes parallel to both axes, resulting in the reflection of light of both planes of polarization.

A uniaxially birefringent material can have either positive or negative uniaxial birefringence. Negative uniaxial birefringence occurs when the index of refraction in the z direction (nz) is greater than the in-plane indices (nx and ny). Positive uniaxial birefringence occurs when the index of refraction in the z direction (nz) is less than the in-plane indices (nx and ny). If n1z is selected to match n2x=n2y=n2z and the first layers of the multilayer film is biaxially oriented, there is no Brewster's angle for p-polarized light and thus there is constant reflectivity for all angles of incidence. Multilayer films that are oriented in two mutually perpendicular in-plane axes are capable of reflecting an extraordinarily high percentage of incident light depending on factors such as the number of layers, f-ratio, and indices of refraction, for example, and are highly efficient mirrors.

In one embodiment, the first optical layers are preferably birefringent polymer layers that are uniaxially- or biaxially-oriented. The birefringent polymers of the first optical layers are typically selected to be capable of developing a large birefringence when stretched. Depending on the application, the birefringence may be developed between two orthogonal directions in the plane of the film, between one or more in-plane directions and the direction perpendicular to the film plane, or a combination of these.

In an exemplary embodiment, the first polymer maintains birefringence after stretching, so that the desired optical properties are imparted to the finished film. In an exemplary embodiment, the second optical layers can be polymer layers that are birefringent and uniaxially- or biaxially-oriented, or the second optical layers can have an isotropic index of refraction that is different from at least one of the indices of refraction of the first optical layers after orientation. In an exemplary embodiment, the second polymer advantageously develops little or no birefringence when stretched, or develops birefringence of the opposite sense (positive-negative or negative-positive), such that its film-plane refractive indices differ as much as possible from those of the first polymer in the finished film. For some applications, it is advantageous for neither the first polymer nor the second polymer to have any absorbance bands within the bandwidth of interest for the film in question. Thus, all incident light within the bandwidth is either reflected or transmitted. However, for some applications, it may be useful for one or both of the first and second polymers to absorb specific wavelengths, either totally or in part.

Materials suitable for making optical films for use in exemplary embodiments of the present disclosure include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof; t-butyl isophthalic acid, trimellitic acid, sodium sulfonated isophthalic acid; 2,2′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof; bisphenol A; 1,8-dihydroxy biphenyl and isomers thereof; and 1,3-bis(2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyethylene terephthalate (PET), and copolymers thereof.

In an exemplary embodiment, a second polymer of the second optical layers is chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,761; 6,352,762; and 6,498,683 and U.S. patent application Ser. No. 09/229,724 and 09/399,531, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

In exemplary embodiments, the second optical layers can be made from a variety of polymers having glass transition temperatures compatible with that of the first polymer and having a refractive index similar to the isotropic refractive index of the first polymer. Examples of other polymers suitable for use in optical films and, particularly, in the second optical layers, other than the CoPEN polymers discussed above, include vinyl polymers and copolymers made from monomers such as vinyl naphthalenes, styrene, maleic anhydride, acrylates, and methacrylates. Examples of such polymers include polyacrylates, polymethacrylates, such as poly (methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers and copolymers such as polyesters and polycarbonates.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008.

Yet other suitable polymers, especially for use in the second optical layers, include polyolefin copolymers such as poly (ethylene-co-octene) (PE-PO) available from Dow-Dupont Elastomers under the trade designation Engage 8200, poly (propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, and PET/sPS, where “co-PET” refers to a copolymer or blend based upon terephthalic acid (as described above), ECDEL is a thermoplastic polyester commercially available from Eastman Chemical Co., and THV is a fluoropolymer commercially available from 3M Company. PMMA refers to polymethyl methacrylate and PETG refers to a copolymer of PET employing a second glycol (usually cyclohexanedimethanol). sPS refers to syndiotactic polystyrene.

Optical films suitable for use with the invention are typically thin. Suitable films may have varying thickness, but particularly they include films with thicknesses of less than 15 mils (about 380 micrometers), more typically less than 10 mils (about 250 micrometers), and preferably less than 7 mils (about 180 micrometers). During processing, a dimensionally stable layer may be included into the optical film by extrusion coating or coextrusion at temperatures exceeding 250° C. Therefore, in some embodiments, the optical film should withstand exposure to temperatures greater than 250° C. The optical film also normally undergoes various bending and rolling steps during processing, and therefore, in the typical exemplary embodiments of the present disclosure, the film should be flexible. Optical films suitable for use in the exemplary embodiments of the present disclosure can also include optional optical or non-optical layers, such as one or more protective boundary layers between packets of optical layers. The non-optical layers may be of any appropriate material suitable for a particular application and can be or can include at least one of the materials used in the remainder of the optical film.

In some exemplary embodiments, an intermediate layer or an underskin layer can be integrally formed with the optical film. One or more under-skin layers are typically formed by co-extrusion with the optical film, for example, to integrally form and bind the first and second layers. An intermediate layer can be integrally or separately formed on the optical film, for example, by being simultaneously co-extruded or sequentially extruded onto the optical film. The underskin layer or layers can include immiscible blends with a continuous phase and a disperse phase which also can aid in creating surface roughness and haze. The disperse phase can be polymeric or inorganic and have about the same or similar refractive index as the continuous phase. In some exemplary embodiments of such clear optical bodies, the refractive indexes of the materials making up the disperse and continuous phases differ from each other by no more than about 0.02. An example of underskin layer with refractive index matched blend is a continuous phase comprising SAN and a disperse phase comprising PETG (copolyester commercially available from Eastman Chemical under the trade name Eastar 6763). An example of underskins with a refractive index mismatched blend is a continuous phase of Xylex 7200 and a disperse phase of polystyrene.

The invention will now be described with reference to the following non-limiting examples.

### EXAMPLES

### Example 1

To demonstrate the use of polycarbonate/polyester blends having sufficient adherence to an optical resin typically used to make structured surfaces, films utilizing one of three different polymeric compositions below were handspread coated with BEF prisms.

The films utilized were: 1) a monolayer film of Makroblend DP4-1386 resin, a polycarbonate/polyethylene terephthalate alloy available commercially from Bayer Plastics, 2) a multilayer optical film (MOF) with an exterior skin layer made of an immiscible blend of 95% by weight Xylex 7200, a polycarbonate/polyester alloy available commercially from GE Plastics, and 5% by weight of TYRIL 880, a SAN available from Dow Chemical, Midland, Mich. and 3) a multilayer optical film (MOF) with a surface layer of Eastman Chemical SA 115, a polycarbonate/polyester alloy available from Eastman Chemical.

In each case, to create a handspread, an 8 inch×12 inch piece of film was taped to one end of a similarly sized microstructured tool with a surface pattern similar to that of a structured surface film available from 3M Company under the trade designation Vikuiti BEF II 90/50, heated to 130° F. (54.4° C.). A pool of uncured optical resin such as that described in U.S. Pat. No. 5,908,874 was deposited between the film and the prismatic tool at the taped end via a pipette.

The film and tool were passed through a nip, spreading the optical resin evenly on the film and tool. The handspread was then passed beneath UV curing lamps (2 banks of 450 W/in (177 W/cm) D bulbs at 70 feet per minute (fpm) (21.3 m/min)) to cure the optical resin. The film was then peeled from the tool and the ease and cleanliness of release of the prisms from the tool was noted. In each case, the prisms released cleanly and easily from the tool, indicating good adhesion of the coating to the alloy skin layer.

### Example 2A

A roll sample of a multilayer polarizing film utilizing Xylex 7200 as the skin layers (See construction shown in FIG. 3) was unwound on a continuous coating line. The top polyolefin skin was continuously stripped off the film and wound onto a scrap winder. The exposed Xylex skin was coated with uncured optical resin and passed over a prismatic microreplication tool with a pattern similar to that available on structured surface films available from 3M Company under the trade designation Vikuiti TBEF 90/24. The resins were cured with UV radiation in a manner similar to that used for the handspreads in Example 1.

### Example 2B

A roll sample of a multilayer polarizing film utilizing SAN 880, available from the Dow Chemical Co., Midland, Mich. as the skin layer was unwound on a continuous coating line. A premask film available from Toray, Japan, under the trade designation 7721 PF was adhered to one side of the multilayer polarizing film to support the film through processing. A layer of uncured BEF resin was applied to the exposed SAN surface of the film and the coated film was passed over a prismatic microreplication tool with a pattern similar to that available on Vikuiti TBEF 90/24. The resins were cured with UV radiation in a manner similar to that used for the handspreads in Example 1.

### Example 3

Each of the polymeric materials explored above, Xylex 7200 and Eastman Chemical SA 115, were coextruded as protective boundary layers on an optical stack of a multilayer optical film. The multilayer optical film was then oriented substantially uniaxially by stretching according to the procedure in U.S. Pat. Nos. 6,936,209; 6,949,212; 6,939,499; or 6,916,440, incorporated herein by reference. Following the substantially uniaxial orientation process, the index of refraction of the high index optical material in the optical stack along the machine direction and the thickness direction matched the refractive index of the polymer used as the protective boundary layer.

Protective boundary layers of Xylex 7200 were coextruded with an optical stack having a high index optical material of 79/21 CoPEN (79% PEN, 21% PET), while protective boundary layers of Eastman Chemical SA 115 were coextruded with an optical stack using LmPEN (90% PEN, 10% PET) as the high index optical material.

Each of the multilayer optical films was co-extruded with strippable polyolefin skins, which allowed the protective boundary layers to be exposed. Each construction gave excellent optics, gain and thickness, while providing excellent adhesion to a structured surface layer.

### Example 4

Xylex 7200 and LmPEN (90% PEN, 10% PET) were each co-extruded as protective boundary layers (PBLs) on the major surfaces of an optical stack of a multilayer optical film. The multilayer film also had applied thereto a strippable skin layer. When the skins were stripped, the PBLs were placed adjacent to a structured surface film in the test described below.

The results were compared to the results from a multilayer optical film composed of the same optical stack but with Xylex 7200 outer skin layers.

As shown in Table 2 below, the test results showed that the thinner Xylex 7200 protective boundary layers were more resistant to damage and out-performed the imprint resistance of the thicker Xylex 7200 skinned material.

### Example 5

A blend of various ratios and thicknesses of LmPEN (90% PEN, 10% PET) and PET were co-extruded with a multilayer optical film made to form a skin layer on a first major surface of the optical stack. The skin layer on the second major surface of the optical stack was Eastman Chemical SA 115. The multilayer optical film was subsequently stretched substantially uniaxially according to the process described in U.S. Pat. Nos. 6,936,209; 6,949,212; 6,939,499; or 6,916,440, at a temperature of 297° F. (147° C.).

The resulting films were tested on the first major surface side using the damage resistance test described below along with several control standards. The results are shown in Table 2 below.

As shown in Table 2, the LmPEN/PET blends and LmPEN skin layers outperformed the control films and showed lower to no visible damage, particularly at high LmPEN and high PET blend compositions.

### Example 6

A blend of 70% of a cyclic olefin copolymer available from Ticona Engineering Polymers, Summit, N.J. under the trade designation Topas 6013 S-04 and 30% Topas 8007 S-04 was co-extruded with a multilayer optical film made to form a skin layer on both surfaces of the optical stack. The multilayer optical film was subsequently stretched uniaxially according to the process in U.S. Pat. Nos. 6,936,209; 6,949,212; 6,939,499; or 6,916,440 at a temperature of 297° F. (147° C.).

The Topas blend skin surface of the resulting film was tested by placing them adjacent to a structured surface film as described in the test method above. The results are shown in Table 2 below and show that the Topas skin layer is resistant to damage.

### Comparative Example C1

An amorphous CoPEN polymer resin was co-extruded with a multilayer optical film made to form a skin layer on both surfaces of the optical stack. The multilayer optical film was subsequently stretched uniaxially according to the process in U.S. Pat. Nos. 6,936,209; 6,949,212; 6,939,499; or 6,916,440 at a temperature of 297° F. (147° C.).

The amorphous CoPEN skin surface of the resulting film was tested by placing them adjacent to a structured surface film as described in the test method above. The result, shown in Table 2, indicates a high extent of visible damage to the exterior skin.

Damage Resistance Test Procedure and Apparatus

Damage resistance testing was performed using the apparatus 200 shown in FIG. 6. An aluminum plate 202 with an appropriately sized well 204 was placed a first die-cut sample 206 of a structured surface film such as prismatic brightness enhancement films, gain diffusers, or films with a matte surface. A second die cut sample 208 of a combined structured surface film and multilayer optical film was placed on top of the first sample 206. The prisms of the sample 208 pointed along a direction substantially normal to the plane of the major surface of the plate 202. A die-cut sample 210 of a multilayer optical film (including any PBLs or skin layers, which are not shown in FIG. 6) was placed adjacent to the structured surface of the sample 208 and in contact with the points of the prisms of the sample 208. On top of the multilayer film sample 210 was placed a 50 g aluminum block 212. In contact with the multilayer film 210 was a layer of a non-stick material 214 such as that available from DuPont under the trade designation TEFLON, while the nonstick layer 214 was backed by a foam tape layer 216. The block 212 was guided into position by a weight guide 218.

Once the sample was placed in the apparatus, it was aged at 85° C. for a period of 24 hours. The film was removed and placed in simulated displays for evaluation. The rating scale in Table 1 below was applied to evaluate the results. In Table 1, HH represents a simulated hand held display, while MTR represents a simulated LCD monitor. The term “on-axis” refers to a view taken normal to the display.

Level 0-2: No Embossing

Rate by dent level (0: none, 1: slight dents, 2: clear dents)
   Level 3-6: Pass/Fail with CIS Systems
On-axis test: observe sample between BEF cut-off angles (brighter area), while normal CIS test is done with all direction
   Level 7-9: Still Visible at On-Axis in CIS #2000

Rate by visibility on a light box (transmitted light), comparing with standard defect samples

TABLE 1

| | HH | MTR | HH on-axis | MTR on-axis |
|---|---|---|---|---|
| Level 0-3 | Pass | Pass | Pass | Pass |
| Level 4 | Fail | Pass | Pass | Pass |
| Level 5 | Fail | Fail | Pass | Pass |
| Level 6 | Fail | Fail | Fail | Pass |
| Level 7-9 | Fail | Fail | Fail | Fail |

TABLE 2

| | | Damage | Damage | Damage Resistant | | Film | Skin Layer |
|---|---|---|---|---|---|---|---|
| Sample | Sample | Resistance | Resistant | Skin Composition | | Thickness | Thickness |
| Number | Description | Rating | Skin Material | LmPEN/PET (%) | | (mil) | (mil) |
| 1 | Example 4 | 3 | Xylex 7200 | — | — | 1.11 | 0.1 |
| 2 | Example 4 | 7 | Xylex 7200 | — | — | 1.8 | 0.4 |
| 3 | Example 5 | 0 | blend −> | 100 | 0 | 1.7 | 0.6 |
| 4 | Example 5 | 0 | blend −> | 85.5 | 14.5 | 1.86 | 0.75 |
| 5 | Example 5 | 0 | blend | 85.5 | 14.5 | 1.54 | 0.43 |
| 6 | Example 5 | 8 | blend | 50 | 50 | 1.95 | 0.84 |
| 7 | Example 5 | 8 | blend | 50 | 50 | 1.71 | 0.6 |
| 8 | Example 5 | 8 | blend | 50 | 50 | 1.5 | 0.39 |
| 9 | Example 5 | 5 | blend | 14.4 | 85.6 | 1.87 | 0.76 |
| 10 | Example 5 | 5 | blend | 14.4 | 85.6 | 1.6 | 0.49 |
| 11 | Example 5 | 1 | blend−> | 0 | 100 | 1.76 | 0.65 |
| 12 | Example 6 | 2 | Topas | — | — | 2.2 | 0.3 |
| C1 | comparative | 9 | Amorphous | — | — | 1.6 | 0.3 |
| | example | | CoPEN | | | | |

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. An optical body comprising:
an optical film having opposing first and second major surfaces;
a first layer on the first major surface of the optical film; and
a second layer on the second major surface of the optical film, wherein at least one of the first and second layers is an adhesion-promoting layer that comprises a polycarbonate/polyester blend resin.

2. The optical body of claim 1, wherein at least one of the first and second layers comprise skin layers.

3. The optical body of claim 1, wherein at least one of the first and second layers comprise protective boundary layers.

4. The optical body of claim 1, wherein at least one of the first and second layers comprise a layer in an optical stack of the optical film.

5. The optical body of claim 2, further comprising a structured surface layer on at least one of the first and second layers.

6. The optical body of claim 3, further comprising a structured surface layer on at least one of the first and second layers.

7. The optical body of claim 4, further comprising a structured surface layer on at least one of the first and second layers.

8. An optical body comprising:
an optical film having opposing first and second major surfaces;
a first layer on the first major surface of the optical film, wherein the first layer is an adhesion-promoting layer that comprises a polycarbonate/polyester blend resin;
a second layer on the second major surface of the optical film, wherein the second layer is an imprint-resistant layer that comprises a polymer selected from the group consisting of crystalline polyesters, copolyesters, olefin homopolymers and olefin copolymers; and
a structured surface film disposed adjacent at least one of the first and second layers.

9. The optical body of claim 8, wherein at least one of the first and second layers comprises a skin layer.

10. The optical body of claim 8, wherein at least one of the first and second layers comprises a protective boundary layer.

11. The optical body of claim 8, wherein at least one of the first and second layers comprises a layer in an optical stack of the optical film.

12. The optical body of claim 8, wherein the crystalline polyesters and copolyesters are selected from the group consisting of PEN and CoPEN.

13. An optical display comprising the optical body of claim 8.

14. A method for making an optical body, consisting of:
providing an optical stack comprising at least one adhesion-promoting layer on a major surface thereof, wherein the adhesion-promoting layer is selected from one of a protective boundary layer and a skin layer, and wherein the adhesion-promoting layer comprises a polyester/polycarbonate blend resin; and
disposing a structured surface film on the additional layer.

15. An optical body comprising:
an optical film;
a first layer on a first major surface of the optical film, and a second layer on a second major surface of the optical film, wherein at least one of the first and second layers is an imprint-resistant layer that comprises a polymer selected from the group consisting of crystalline polyesters, copolyesters, olefin homopolymers and olefin copolymers.

16. The optical body of claim 15, wherein the crystalline polyesters and copolyesters are selected from the group consisting of PEN and CoPEN.

17. The optical body of claim 15, further comprising a structured surface film disposed adjacent at least one of the first and second layers.

18. An optical display comprising the optical body of claim 15.

19. An optical body comprising:
an optical film having opposing first and second major surfaces;
a first layer on the first major surface of the optical film; and
a second layer on the second major surface of the optical film,
wherein at least one of the first and second layers is an adhesion-promoting layer that comprises a styrene copolymer.

20. The optical body of claim 19, wherein at least one of the first and second layers comprise skin layers.

21. The optical body of claim 19, wherein at least one of the first and second layers comprise protective boundary layers.

22. The optical body of claim 19, wherein at least one of the first and second layers comprise a layer in an optical stack of the optical film.

23. The optical body of claim 20, further comprising a structured surface layer on at least one of the first and second layers.

24. The optical body of claim 21, further comprising a structured surface layer on at least one of the first and second layers.

25. The optical body of claim 22, further comprising a structured surface layer on at least one of the first and second layers.

26. A method for making an optical body, consisting of:
providing an optical stack comprising at least one adhesion-promoting layer on a major surface thereof, wherein the adhesion-promoting layer is selected from one of a protective boundary layer and a skin layer, and wherein the adhesion-promoting layer comprises a styrene copolymer; and
disposing a structured surface film on the adhesion-promoting layer.
